(19) United States
(12) Patent Application Publication
(10) Pub. No.: US 2023/0274014 A1
(43) Pub. Date: Aug. 31, 2023

(54) MANAGEMENT APPARATUS, CONTROL METHOD, COMPUTER READABLE MEDIUM, AND ACCESS CONTROL SYSTEM

(71) Applicants: NEC Corporation, Minato-ku, Tokyo (JP); NEC Solution Innovators, Ltd., Koto-ku, Tokyo (JP)

(72) Inventors: Takumi HIROTA, Tokyo (JP); Kazuki YOSHIDA, Tokyo (JP)

(73) Assignees: NEC Corporation, Minato-ku, Tokyo (JP); NEC Solution Innovators, Ltd., Koto-ku, Tokyo (JP)

(21) Appl. No.: 18/009,037

(22) PCT Filed: Jun. 11, 2020
(86) PCT No.: PCT/JP2020/023095

§ 371 Date: Dec. 8, 2022

(51) Int. Cl. G06F 21/62; G06F 21/60

(52) U.S. Cl. CPC G06F 21/6218; G06F 21/604; G06F 2221/2107

(57) ABSTRACT

A management apparatus (4000) detects that an upload file (30) has been uploaded to a file server apparatus (3000). The management apparatus (4000) acquires the upload file (30) and access right information (12) indicating an access right for the upload file (30) from the file server apparatus (3000). The management apparatus (4000) encrypts the upload file (30) and associates the access right information (12) with the encrypted upload file (30). The management apparatus (4000) transmits, to the file server apparatus 3000, the upload file (30) with which the access right information (12) has been associated and which has been encrypted.

### TECHNICAL FIELD

The present invention relates to control of access to files.

### BACKGROUND ART

Technologies for enabling a plurality of users to share files through a network are being developed. Further, in such file sharing, encryption of files and control of access thereto based on the access right therefor are performed in order to prevent unauthorized use or the like of the files.

As prior-art literature disclosing a technology for realizing management of such shared files, for example, there is PTL1. PTL1 discloses a system for controlling access to a file by a user device. When the user device accesses an encrypted shared file, it requests a decryption key from a management server. Upon receiving the request, the management server acquires, from an associated server, information about the access right for a shared folder in which the shared file is stored. The management server transmits a decryption key and the information about the access right to the user device. The user device uses the shared file by using the acquired decryption key in accordance with the access right indicated in the acquired information about the access right.

### CITATION LIST

### Patent Literature

Patent Literature 1: International Patent Publication No. 2017/064780

### SUMMARY OF INVENTION

### Technical Problem

In the system disclosed in PTL1, when a user accesses a file from the user device, access from the user device to the management server occurs even when the user does not have an access right for the file. Therefore, the load on the management server increases.

The present invention has been made in view of the above-described problem, and an objective thereof is to provide a technology for reducing, in an environment in which files are shared by using a server, the load on the server.

### Solution to Problem

A management apparatus according to the present invention includes: a detection unit configured to detect that a file is uploaded to a file server apparatus; an acquisition unit configured to acquire the file and access right information indicating an access right for the file from the file server apparatus; and an output unit configured to encrypt the file, associate the access right information with the encrypted file, and output the file to the file server apparatus.

A control method according to the present invention is performed by a management apparatus. The control method includes: a detection step of detecting that a file is uploaded to a file server apparatus; a step of acquiring the file and access right information indicating an access right for the file from the file server apparatus; and an output step of encrypting the file, associating the access right information with the encrypted file, and outputting the file to the file server apparatus.

A computer readable medium according to the present disclosure stores a program for causing a management apparatus to perform a control method according to the present invention.

An access control system according to the present disclosure includes a file server apparatus and a management apparatus. The file server apparatus is configured to acquire an uploaded file. The management apparatus is configured to: detect that a file is uploaded to the file server apparatus; acquire the file and access right information indicating an access right for the file from the file server apparatus; and encrypt the file, associate the access right information with the encrypted file, and output the file to the file server apparatus, and the file server apparatus is configured to store the file output from the management apparatus in a storage device.

### Advantageous Effects of Invention

A technology for reducing, in an environment in which files are shared by using a server, the load on the server is provided.

### BRIEF DESCRIPTION OF DRAWINGS

FIG. 1 shows an example of an overview of operations performed by a management apparatus according to a first example embodiment;

FIG. 2 is a block diagram showing an example of a functional configuration of the management apparatus according to the first example embodiment;

FIG. 3 is a block diagram showing an example of a hardware configuration of a computer that implements the management apparatus;

FIG. 4 is a flowchart showing an example of a flow of processes performed by the management apparatus according to the first example embodiment;

FIG. 5 is a diagram for conceptually explaining access control based on a reference location;

FIG. 6 shows a specific example of implementation of an access control system;

FIG. 7 shows an example of a flow for processing an uploaded file in the example of the implementation of the access control system; and

FIG. 8 shows an example of a flow of control of access to a file in the example of the implementation of the access control system.

### EXAMPLE EMBODIMENT

An example embodiment according to the present disclosure will be described hereinafter in detail with reference to the drawings. The same reference numerals (or symbols) are assigned to the same or corresponding components throughout the drawings, and redundant descriptions thereof are omitted as appropriate for clarifying the explanation.

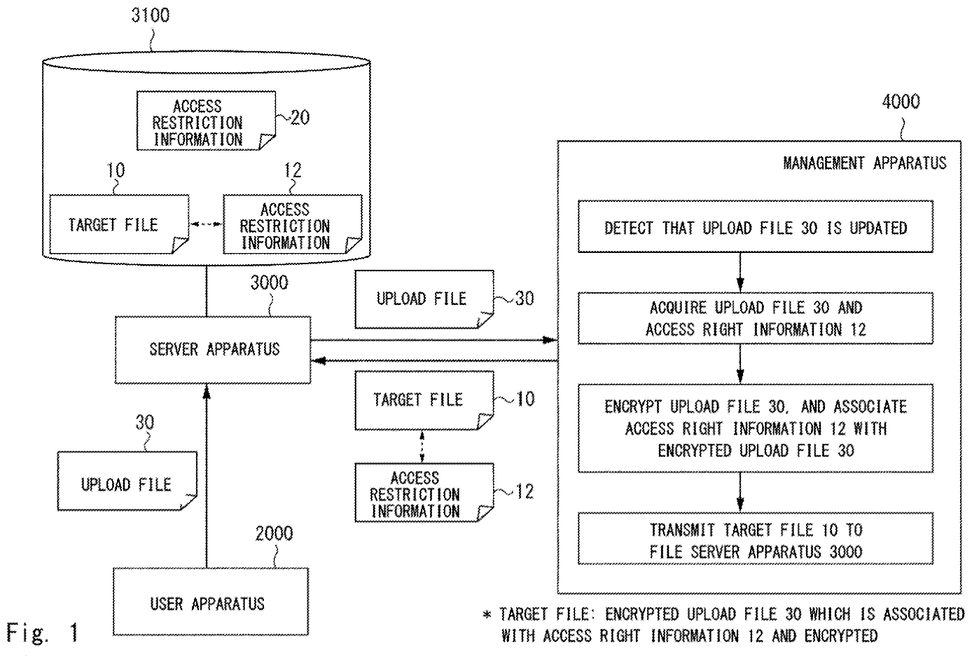

FIG. 1 shows an example of an overview of operations performed by a management apparatus 4000 according to a first example embodiment. Note that FIG. 1 is a diagram for facilitating understanding of the overview of the management apparatus 4000, and the operations performed by the management apparatus 4000 are not limited to those shown in FIG. 1.

The management apparatus 4000, together with a user apparatus 2000 and a file server apparatus 3000, constitutes an access control system 5000. In the access control system 5000, access to a file made by the user apparatus 2000 is controlled based on the access right thereof. Note that among the files accessed by the user apparatus 2000, a file for which access control using the access control system 5000 is performed is called a target file 10.

A target file 10 is associated with access right information 12 indicating an access right for the target file 10. Further, the target file 10 is a file encrypted by the management apparatus 4000. In other words, a file which is associated with the access right information 12 and encrypted by the management apparatus 4000 is handled as a target file 10.

The file server apparatus 3000 acquires a file that should be managed as a new target file 10 from the user apparatus 2000. In other words, the file server apparatus 3000 accepts the upload of a file from the user apparatus 2000. Note that the user apparatus 2000 is an apparatus that is used by a user who accesses the target file 10. Hereafter, a file that is uploaded to the file server apparatus 3000 as described above is called an upload file 30.

The management apparatus 4000 detects that an upload file 30 has been acquired by the file server apparatus 3000 (i.e., an uploaded file 30 has been uploaded to the file server apparatus 3000), and then acquires the upload file 30 from the file server apparatus 3000. The management apparatus 4000 encrypts the acquired upload file 30. Further, the management apparatus 4000 acquires access right information 12 indicating an access right for the upload file 30.

Note that in the access control system 5000, the access right information 20, which indicates an access right for each file, each directory, or the like, is stored in a storage device 3100 accessible from the file server apparatus 3000. The access right information 12, which is associated with the upload file 30, is information indicating an access right that is applied to the corresponding upload file 30, among access rights indicated by the access right information 20.

The management apparatus 4000 associates the access right information 12 with the encrypted upload file 30. For example, the access right information 12 is included in the metadata of the encrypted upload file 30. Then, the management apparatus 4000 transmits, to the file server apparatus 3000, the upload file 30 (i.e., the target file 10) that has been associated with the access right information 12 and has been encrypted. The file server apparatus 3000 puts the target file 10 received from the management apparatus 4000 in the storage device 3100.

### <Example of Advantageous Effect>

The management apparatus 4000 according to this example embodiment detects that an upload file 30 has been uploaded to the file server apparatus 3000, encrypts the upload file 30, and then associates access right information 12 with the upload file 30. Then, the upload file 30 (the target file 10), with which the access right information 12 has been associated and which has been encrypted, is put in the storage device 3100 of the file server apparatus 3000.

Since the access right information 12 is associated with the target file 10 as described above, the user apparatus 2000 can determine whether or not the user has an access right for the target file 10 by using the access right information 12 associated with the target file 10. Therefore, there is no need to access the management apparatus 4000 just for checking whether or not the user has the access right. Consequently, the load on the management apparatus 4000 can be reduced.

The user apparatus 2000 according to this example embodiment will be described hereinafter in a more detailed manner.

### <Example of Functional Configuration>

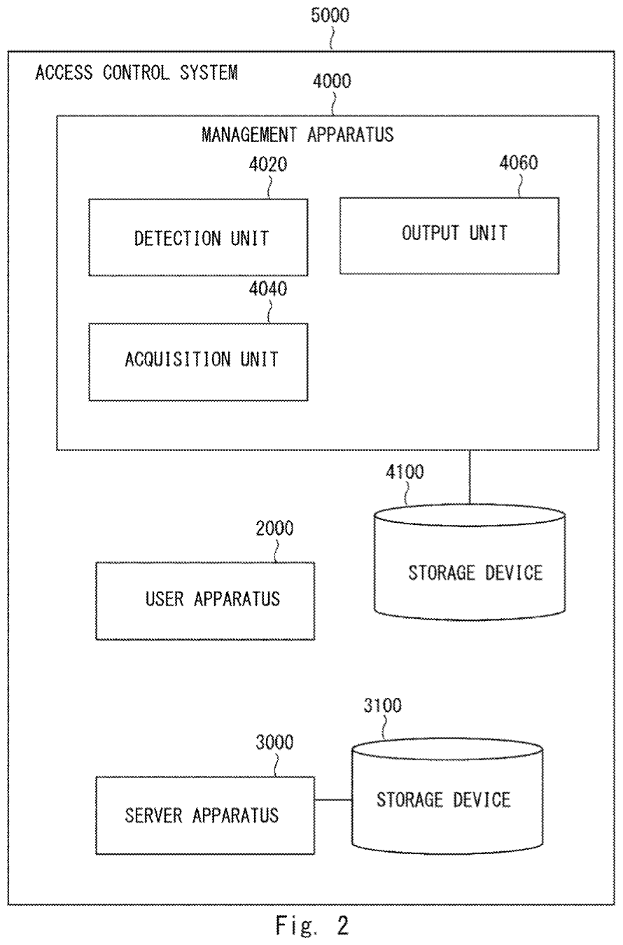

FIG. 2 is a block diagram showing an example of a functional configuration of the management apparatus 4000 according to the first example embodiment. As described above, the management apparatus 4000, together with the user apparatus 2000 and the file server apparatus 3000, constitutes the access control system 5000. The management apparatus 4000 includes a detection unit 4020, an acquisition unit 4040, and an output unit 4060.

The detection unit 4020 detects that the file server apparatus 3000 has acquired an upload file 30. The acquisition unit 4040 acquires the upload file 30 from the file server apparatus 3000. Further, the acquisition unit 4040 acquires access right information 12 for the upload file 30. The output unit 4060 encrypts the upload file 30 and associates the access right information 12 with the encrypted upload file 30. The output unit 4060 outputs the upload file 30 (the target file 10), with which the access right information 12 is associated, to the file server apparatus 3000. Further, when the management apparatus 4000 uses a right template (which will be described later), a storage device 4100, which is a storage device accessible from the management apparatus 4000, is provided.

### <Example of Hardware Configuration>

Each functional component of the management apparatus 4000 may be implemented by hardware (e.g., a hard-wired electronic circuit) that realizes the functional component, or by a combination of hardware and software (e.g., a combination of an electronic circuit and a program for controlling the electronic circuit). An example case where each functional component of the management apparatus 4000 is implemented by a combination of hardware and software will be further described hereinafter.

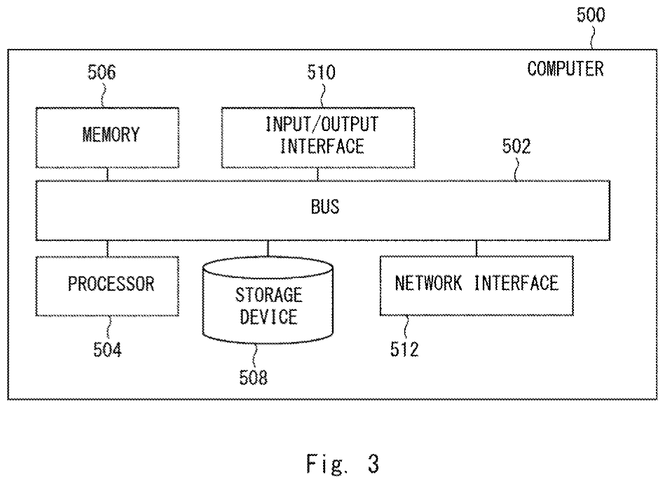

FIG. 3 is a block diagram showing an example of a hardware configuration of a computer 500 that implements the management apparatus 4000. The computer 500 is any type of computer. For example, the computer 500 is a stationary computer such as a PC (Personal Computer) or a server machine. Alternatively, the computer 500 is, for example, a mobile computer such as a smartphone or a tablet device. The computer 500 may be a special-purpose computer designed to implement the management apparatus 4000, or may be a general-purpose computer.

For example, each function of the management apparatus 4000 is implemented by the computer 500 by installing a certain application in the computer 500. The aforementioned application is implemented by a program for implementing the functional components of the management apparatus 4000.

The computer 500 includes a bus 502, a processor 504, a memory 506, a storage device 508, an input/output interface 510, and a network interface 512. The bus 502 is a data transmission path through which the processor 504, the memory 506, the storage device 508, the input/output interface 510, and the network interface 512 transmit and receive data to and from each other. However, the method for connecting the processor 504 and the like to each other is not limited to connections through buses.

The processor 504 is one of various types of processors such as a CPU (Central Processing Unit), a GPU (Graphics Processing Unit), or an FPGA (Field-Programmable Gate Array). The memory 506 is a primary storage device implemented by using a RAM (Random Access Memory) or the like. The storage device 508 is a secondary storage device implemented by using a hard disk drive, an SSD (Solid State Drive), a memory card, or a ROM (Read Only Memory).

The input/output interface 510 is an interface for connecting the computer 500 with an input/output device(s). For example, an input device such as a keyboard and an output device such as a display device are connected to the input/output interface 510.

The network interface 512 is an interface for connecting the computer 500 to a network. The network may be a LAN (Local Area Network) or a WAN (Wide Area Network).

The storage device 508 stores a program for implementing each functional component of the management apparatus 4000 (a program for implementing the above-described application). The processor 504 implements each functional component of the management apparatus 4000 by loading the program into the memory 506 and executing the loaded program.

The management apparatus 4000 may be implemented by one computer 500, or may be implemented by a plurality of computers 500. In the latter case, the configurations of the computers 500 do not necessarily have to be identical to each other, i.e., may be different from each other.

Similarly to the management apparatus 4000, each of the user apparatus 2000 and the file server apparatus 3000 will be implemented by various computers. Each of the computer that implements the user apparatus 2000 and the computer that implements the file server apparatus 3000 has, for example, the hardware configuration shown in FIG. 3 like the computer 500 that implements the management apparatus 4000. However, the hardware configurations of the computers implementing the user apparatus 2000, the file server apparatus 3000, and the management apparatus 4000 may be different from one another. Further, each of the user apparatus 2000 and the file server apparatus 3000 may be implemented by a plurality of computers.

The computers implementing the user apparatus 2000, the file server apparatus 3000, and the management apparatus 4000 are connected to each other through a network so that they can communicate with each other. The network connecting them to each other may be a LAN or a WAN. Further, two of these three apparatuses may be connected to each other by a LAN, and they may be connected to the remaining one through a WAN. For example, the file server apparatus 3000 and the management apparatus 4000 are provided in the same LAN, and the user apparatus 2000 is connected to the file server apparatus 3000 and the management apparatus 4000 through a WAN.

### <Flow of Processes>

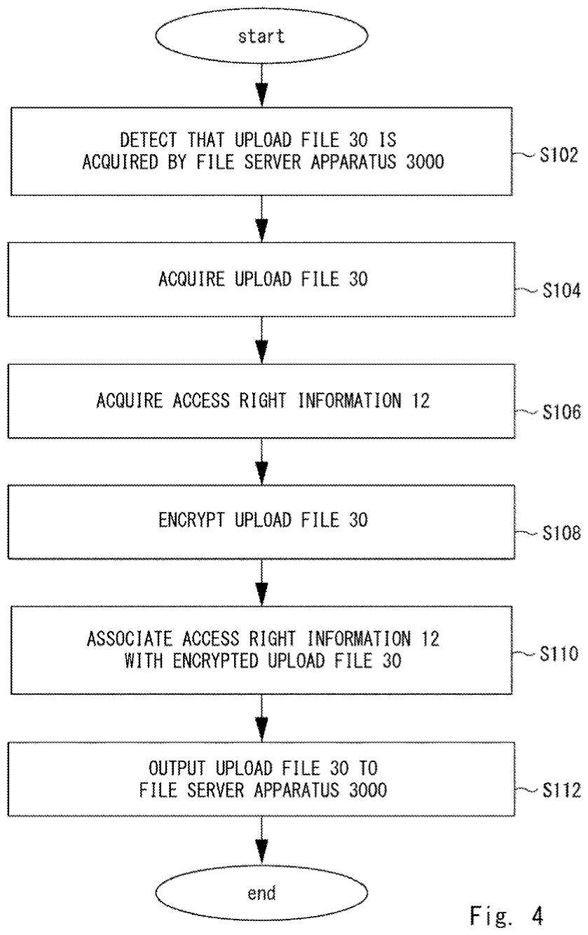

FIG. 4 is a flowchart showing an example of a flow of processes performed by the management apparatus 4000 according to the first example embodiment. The detection unit 4020 detects that the file server apparatus 3000 has acquired an upload file 30 (S102). The acquisition unit 4040 acquires the upload file 30, the acquisition of which has been detected (S104). The acquisition unit 4040 acquires access right information 12 for the upload file 30 (S106). The output unit 4060 encrypts the acquired upload file 30 (S108). The output unit 4060 associates the access right information 12 with the encrypted upload file 30 (S110). The output unit 4060 outputs the upload file 30 (the target file 10) to the file server apparatus 3000 (S112).

### <As to Access Right Information 20>

The access right information 20 stored in the storage device 3100 of the file server apparatus 3000 will be described hereinafter. The access right information 20 is information for controlling access to the target file 10 made by the user apparatus 2000. For example, the access right information 20 indicates information as to “which user can access which file, and what kind of access she/he can perform”.

In the access right information 20, an access right may be set for each user or for each group of users. Further, in the access right information 20, an access right may be individually set for each of various types of operations performed for files, or collectively set for all types of the operations.

In the access right information 20, an access right may be set for each file or each group of files. In the latter case, for example, an access right is set for a location (a directory) where files are stored. That is, the same access right is set for the files stored in the same directory. Note that when a sub-directory is stored in a directory for which an access right is set, it is preferable that the same access right is set for files and sub-directories stored in that sub-directory in a recursive manner.

Note that in the case where, for a given file, there are an access right individually set for this file and an access right set for a group to which this file belongs, how to handle the access to the file is arbitrarily determined. For example, only one of the two types of access rights is applied.

Note that in the case where an access right is set for a directory, the access right for a given file may be an access right that is set for a directory in which this file was stored in the past (hereinafter, called a reference location), instead of an access right that is set for a directory in which this file is currently stored. For example, assume that the target file 10 held by the file server apparatus 3000 (the target file 10 stored in the storage device 3100) has been copied to the user apparatus 2000. Further, assume that, after that, the user apparatus 2000 accesses the target file 10 held in the user apparatus 2000 itself. In this case, it is possible that the location in the file server apparatus 3000 where the target file 10 is stored is set as the reference location of the target file 10. In such a situation, by using the access right set for the reference location, it is possible to carry out access control based on the access right set for the location in the file server apparatus 3000 where the target file 10 is (or was) stored even after the target file 10 is copied to the outside of the file server apparatus 3000.

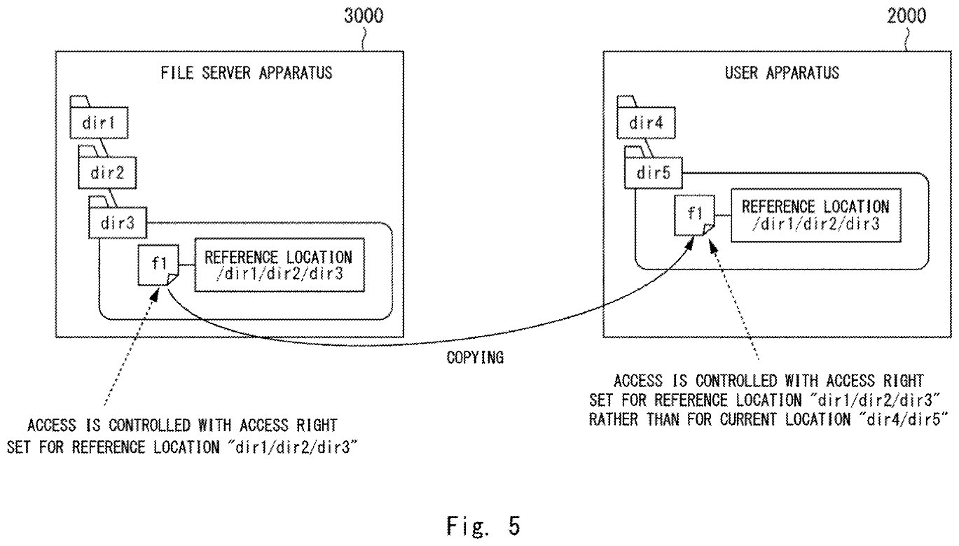

FIG. 5 is a diagram for conceptually explaining access control based on the reference location. In FIG. 5, a file f1 is stored in a directory “/dir1/dir2/dir3” provided in the file server apparatus 3000. Further, the directory “/dir1/dir2/dir3” in the file server apparatus 3000 is set as the reference location of the file f1.

Further, in FIG. 5, the file f1 has been copied from the directory “/dir1/dir2/dir3” in the file server apparatus 3000 to a directory “/dir4/dir5” in the user apparatus 2000. In this case, when the target file 10 copied to the user apparatus 2000 is accessed, the access to the target file 10 is controlled based on the access right set for the directory “/dir1/dir2/dir3” in the file server apparatus 3000, which is the reference location, rather than the directory “/dir4/dir5” in the user apparatus 2000, which is the location where the target file 10 is currently stored. Therefore, for example, even if the user, who is operating the user apparatus 2000, has an access right for the file stored in the directory “/dir4/dir5” of the user apparatus 2000, the user cannot access the target file 10 stored in the directory “/dir4/dir5” of the user apparatus 2000 unless she/he has an access right for the directory “/dir1/dir2/dir3” of the file server apparatus 3000.

Further, assume that the file f1 is deleted in the file server apparatus 3000. In this case, the system may be configured so that even the user having an access right for the reference location of the file f1 cannot access the file f1 copied to the user apparatus 2000. For example, when the target file 10 is deleted in the file server apparatus 3000, the user apparatus 2000, which holds the copy of that target file 10, is notified of the deletion. Upon receiving the notification, the user apparatus 2000 makes it impossible to access the target file 10 stored in the user apparatus 2000 by updating the access right information 12 for the target file stored in the user apparatus 2000 corresponding to the deleted target file 10.

Note that the reference location of the target file 10 can be updated. For example, the right to change the reference location of the target file 10 is given to a certain user. Suppose that the target file 10 stored in the file server apparatus 3000 has been moved to another directory in the file server apparatus 3000 by the aforementioned user in this case. In this process, for example, the file server apparatus 3000 ask the user to select whether or not to change the reference location of the moved target file 10 to the directory to which the target file 10 has been moved. When it is selected to change the reference location, the file server apparatus 3000 sets the directory to which the target file 10 has been moved as a new reference location of the moved target file 10. On the other hand, when it is selected not to change the reference location, the reference location is not changed. Note that the file server apparatus 3000 may not ask the user to select whether or not to change the reference location. In this case, when the target file 10 is moved by the user who has the right to change the reference location, the reference location of the target file 10 is automatically changed.

Note that the system may be configured so that, the user can perform, in addition to the normal move operation, an additional move operation that involves the change of the reference location. In this case, when the normal move operation is performed for the target file 10, the reference location of the target file 10 is not changed. On the other hand, when the move operation involving the change of the reference location is performed, the reference location of the target file 10 is changed to the directory to which the target file 10 has been moved.

Note that an arbitrary method can be adopted for the method for enabling the two types of move operations, i.e., the normal move operation and the move operation involving the change of the reference location. For example, there is a possible way in which a move operation performed by using a left button of a mouse is handled as the normal move operation, while a move operation performed by using a right button of the mouse is handled as the move operation involving the change of the reference location.

Note that although the case in which the reference location is updated in response to a file being moved has been descried in the above description, the reference location may be updated in a similar manner in response to a file being copied. In this case, reference locations different from each other may be set for the two files containing the same contents. That is, the reference location for the original file is not changed, and the directory to which the file has been copied is set as the reference location for the file generated by the copy operation.

There are various specific structures of the access right information 20. For example, the access right information 20 associates 1) identification information of a file or directory, 2) identification information of users who can access the file or the directory, and 3) the type of access that each of the users is permitted to perform for the file or the directory, with each other. In another example, the access right information 20 may associate 1) identification information of a user, 2) identification information (e.g., a path) of a file or directory that the user identified by the identification information can access, and 3) the type of access (read, write, execution, or the like) that the user is permitted to perform for the file or the directory, with each other.

### <As to Access Right Information 12>

The access right information 12 is information indicating an access right for its corresponding target file 10. For example, the access right information 12, which is associated with the target file 10, indicates “identification information of a user who is permitted to access to this target file 10, and the type of access that this user is permitted to perform”. For example, assume that a setting “User U1 is permitted read, write, and execution” and a setting “User group G1 is permitted only read” are made for the file f1. In this case, for example, the access right information 12 associated with the file f1 shows information “U1, [r,w,x]” and “G1, [r]”. Note that the part enclosed in [ ] indicates the type of permitted access. Further, the symbols r, w, and x represent read, write, and execution, respectively.

<Detection of Upload file: S102>

The detection unit 4020 detects that the file server apparatus 3000 has acquired an upload file from the user apparatus 2000 (i.e., an upload file 30 has been uploaded to the file server apparatus 3000) (S102). Various methods may be adopted to carry out the above-described detection. For example, the management apparatus 4000 periodically transmits, to the file server apparatus 3000, a request inquiring whether or not a new upload file 30 has been uploaded to the file server apparatus 3000 (a request inquiring whether or not there is an upload file 30 that has been newly uploaded to the file server apparatus 3000 after the last request).

Upon receiving the above-described request, the file server apparatus 3000 transmits a response to the request to the management apparatus 4000. When there is a new upload file 30, the file server apparatus 3000 transmits a response containing identification information of the new upload file 30. On the other hand, when there is no new upload file 30, the file server apparatus 3000 transmits a response by which it is possible to know that there is no new upload file 30 (e.g., a response that does not contain identification information of any upload file 30).

The detection unit 4020 detects that a new upload file 30 has been uploaded to the file server apparatus 3000 by using the above-described response. Specifically, by receiving a response containing identification information of an upload file 30, the detection unit 4020 can detect that the newly upload file 30 having the identification information has been uploaded.

Note that when there is a plurality of new upload files 30, identification information of each of the plurality of upload file 30 may be included in the response.

In another example, when there is a new upload file 30, a notification containing identification information of the new upload file 30 may be transmitted from the file server apparatus 3000 to the management apparatus 4000. Hereafter, this notification is called an upload notification. In this case, the detection unit 4020 detects that an upload file 30 has been uploaded to the file server apparatus 3000 by receiving an upload notification transmitted from the file server apparatus 3000.

Note that an upload notification may be transmitted each time the file server apparatus 3000 acquires a new upload file 30, or may be transmitted at regular intervals. In the latter case, the upload notification contains identification information of each of one or more upload files 30 that has been uploaded after the last upload notification.

Note that the above-described response and the upload notification (hereinafter also called an upload notification or the like) may contain the upload file 30 itself. Further, when an access right is set by using a reference location, the reference location corresponding to the upload file 30 is included in the upload notification or the like.

### <Acquisition of Upload File 30: S104>

The acquisition unit 4040 acquires an upload file 30 from the file server apparatus 3000 (S104). When the upload file 30 is contained in the upload notification or the like, the acquisition unit 4040 acquires the upload file 30 contained in them. On the other hand, when the upload file 30 is not contained in the upload notification or the like, the acquisition unit 4040 acquires the upload file 30 by using the identification information of the upload file 30 contained in the upload notification or the like Specifically, by transmitting a request containing the identification information of the upload file 30 to the file server apparatus 3000, the acquisition unit 4040 requests the upload file 30 specified by this identification information from the file server apparatus 3000. Upon receiving this request, the file server apparatus 3000 transmits the upload file 30 having the identification information indicated in the request to the management apparatus 4000.

### <Acquisition of Access Right Information 12: S106>

The management apparatus 4000 also acquires access right information 12 that will be associated with the upload file 30 (S106). For example, by transmitting a request indicating the identification information of the upload file to the file server apparatus 3000, the management apparatus 4000 requests the file server apparatus 3000 to transmit the access right information 12 to be associated with this upload file 30.

Upon receiving this request, the file server apparatus 3000 generates access right information 12 to be associated with the upload file 30 based on the access right information 20. For example, the file server apparatus 3000 determines, by searching the access right information 20, an access right set for a file group including the upload file 30 (e.g., a directory in which the upload file 30 is stored), and generates access right information 12 indicating this access right. In another example, when an access right is individually set for the upload file 30 in the access right information 20, the file server apparatus 3000 generates access right information 12 indicating this access right. The file server apparatus 3000, which has generated the access right information 12, transmits this access right information 12 as a response to the above-described request to the management apparatus 4000.

Note that, when there is an access right set for a file group including the upload file 30 and an access right individually set for the upload file 30 in the access right information 20, how to handle these access rights is arbitrarily determined. For example, in this case, access right information 12 indicating only the access right individually set for the upload file 30 may be generated.

Further, when a request for acquiring an upload file 30 is transmitted from the management apparatus 4000 to the file server apparatus 3000, the acquisition of the upload file 30 and the acquisition of access right information 12 therefor may be carried out by using one request.

Note that when the access right set for the above-described reference location is used, the management apparatus 4000 includes the reference location of the upload file 30 in the request for the access right information 12. In this case, the request may not include the identification information of the upload file 30. However, when the upload file 30 is acquired by this request, the identification information of the upload file 30 is included in the request.

### <Reuse of Access Right Information 12 Acquired in the Past>

The acquisition unit 4040 may reuse access right information 12 acquired in the past without acquiring access right information 12 from the file server apparatus 3000. For example, the acquisition unit 4040 puts, as a template, each access right information 12 acquired in the past in the storage device 4100. The storage device 4100 is a storage device accessible from the management apparatus 4000. Hereafter, the access right information 12 stored as a template in the storage device 4100 is called a right template.

For example, assume that, in the access control system 5000, an access right set for a directory in which a target file 10 is stored is also set for this target file 10. In this case, in the storage device 4100, a right template that indicates access right information 12 set for a directory is stored in association with the path of that directory. The acquisition unit 4040 searches for a right template for a new upload file 30 by using the path of a directory in which this upload file is stored. When a right template corresponding to the aforementioned path is stored in the storage device 4100, the acquisition unit 4040 acquires this right template as access right information 12 to be associated with the upload file 30.

In this case, the management apparatus 4000 needs to know the directory in which the upload file 30 is stored. Therefore, for example, the system may be configured so that the path to the directory in which the upload file 30 is stored is provided together with the identification information of the upload file 30 from the file server apparatus 3000 to the management apparatus 4000. However, when the path of the upload file 30 is used as the identification information of the upload file 30, the acquisition unit 4040 can determine the path of the directory in which the upload file 30 is stored by using the identification information of the upload file 30.

Further, assume that the reference location is used for access control. In this case, the storage device 4100 stores, in association with a reference location, a right template indicating access right information 12 that is set for a file having that reference location. Therefore, the acquisition unit 4040 searches for a right template associated with the reference location of a new upload file 30. When the right template associated with this reference location is stored in the storage device 4100, the acquisition unit 4040 acquires this right template as access right information 12 to be associated with the upload file 30.

In this case, the management apparatus 4000 needs to determine the reference location of the upload file 30. Therefore, the file server apparatus 3000 is configured to provide the management apparatus 4000 with information for determining the reference location of the upload file 30 together with the identification information of the file server apparatus 3000. However, when there is a rule that “set a directory in which an upload file 30 is stored when it is uploaded as a reference location of the upload file 30”, the acquisition unit 4040 can determine the reference location of the upload file 30 by determining the directory in which the upload file 30 is to be stored.

Note that, in either case, when no right template that meets the condition is found as a result of the search of the storage device 4100, the acquisition unit 4040 acquires access right information 12 to be set for the upload file 30 from the file server apparatus 3000.

In the case where the right template is used as described above, when the acquisition unit 4040 cannot acquire a right template from the storage device 4100 and therefore acquires access right information 12 from the file server apparatus 3000, it puts this access right information 12 as a new right template in the storage device 4100.

Further, when the content of the access right information 20 held in the file server apparatus 3000 is updated, it is necessary to update the right template. Therefore, when the access right information 20 is updated, the file server apparatus 3000 transmits its updated content to the management apparatus 4000. The management apparatus 4000 updates a part of the contents of the right template that is affected by the above-described updating based on the updated content provided from the file server apparatus 3000.

For example, assume that, in the access right information 20, an access right for a directory “/dir1/dir2” is updated to “User group G2 is permitted read”. In this case, the file server apparatus 3000 associates the path “/dir1/dir2” of the directory for which the access right has been updated with the updated content of the access right “User group G2 is permitted read”, and transmits them to the management apparatus 4000. Upon receiving them, the management apparatus 4000 searches for the right template by using the path of the directory “/dir1/dir2”. Then, when there is a corresponding right template, the management apparatus 4000 updates the content of this right template to “User group G2 is permitted read”.

### <Encryption of Upload File 30: S108>

The output unit 4060 encrypts the upload file 30 and associates the access right information 12 with the encrypted upload file 30. The algorithm used to encrypt the upload file 30 is arbitrarily determined.

### <Association of Access Right Information 12 for Upload File 30: S110>

The access right information 12 is associated with the upload file 30 in such manner that the user apparatus 2000 can refer to the access right information 12 when the user apparatus 2000 accesses the upload file 30 with which the access right information 12 is associated. For example, the output unit 4060 associates the access right information 12 with the upload file 30 by including the access right information 12 in the metadata of the upload file 30.

### <Output of Target File 10: S112>

The output unit 4060 transmits the target file 10 (the upload file 30 which is encrypted and associated with the access right information 12) to the file server apparatus 3000. The file server apparatus 3000 puts the received the target file 10 in the storage device 3100. Note that since the target file 10 is associated with the access right information 12, the access right information 12 is also put together with the target file 10 in the storage device 3100.

### <Specific Example of Implementation of Access Control System 5000>

In order to further facilitate the understanding of the access control system 5000, a specific example of the implementation of the access control system 5000 will be described hereinafter. However, the example of the implementation described below is merely an example of a specific embodiment of the access control system 5000, and the specific method for implementing the access control system 5000 is not limited to the example described below.

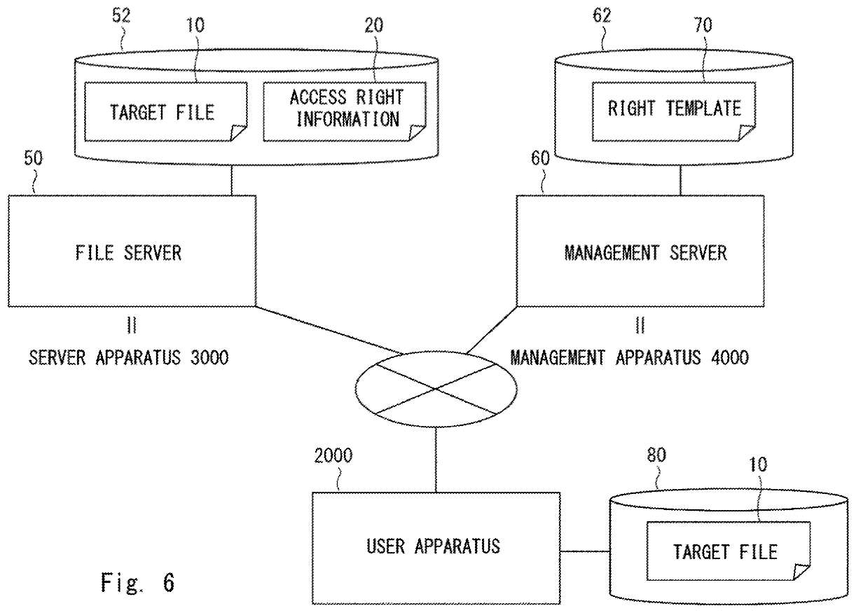

FIG. 6 shows a specific example of the implementation of the access control system 5000. In this example of the implementation, a file server 50 and a management server 60 are provided as apparatuses that function as the file server apparatus 3000 and the management apparatus 4000, respectively. In the example shown below, the access control for the target file 10 is performed based on the reference location set for the target file 10.

The storage device 52 is a storage device corresponding to the storage device 3100 included in the file server apparatus 3000, and the target file 10 and access right information 20 are stored therein. Note that the access right information 12 is contained in the metadata of the target file 10, though it is not shown.

A storage device 62 is a storage device corresponding to the storage device 4100 included in the management apparatus 4000, and the right template 70 is stored therein.

A storage device 80 is a storage device accessible from the user apparatus 2000. The target file 10 that the user apparatus 2000 has downloaded from the file server 50 is stored in the storage device 80. Note that the access right information 12 is also contained in the metadata of the target file 10 stored in the storage device 80, though it is not shown.

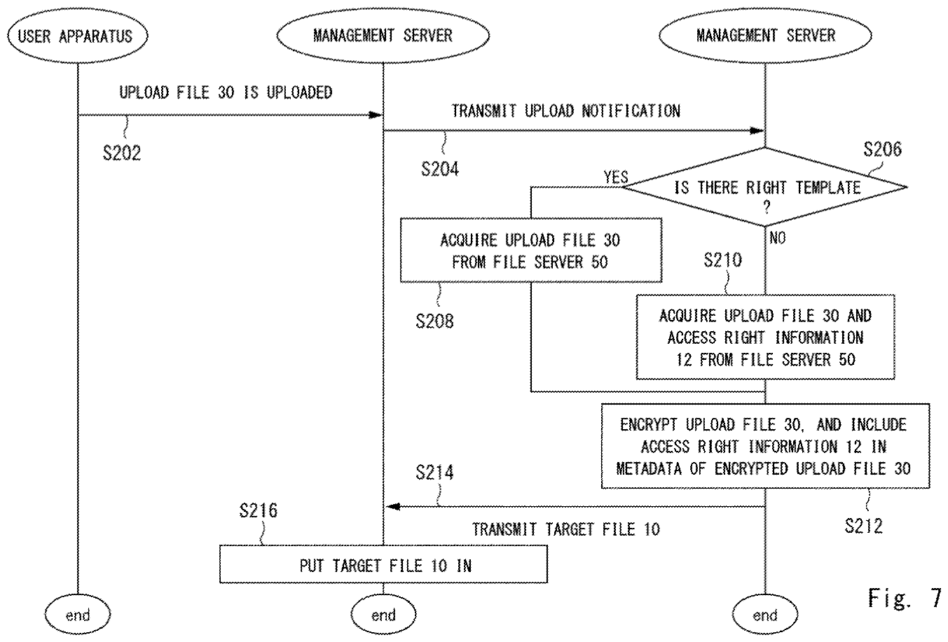

FIG. 7 is a flowchart showing an example of a flow along which a new upload file 30 is processed in the access control system 5000. The file server 50 acquires an upload file 30 uploaded from the user apparatus 2000 (S202). Upon acquiring the upload file 30, the file server 50 transmits an upload notification to the management server 60 (S204). The upload notification includes the identification information of the upload file 30 and the reference location of the upload file 30.

The management server 60 determines whether or not a right template corresponding to the reference location of the upload file 30 is stored in the storage device 62 (corresponding to the storage device 4100) (S206). When a right template corresponding to the reference location of the upload file 30 is stored in the storage device 62 (S206: Yes), this right template is used as access right information 12 to be associated with the upload file 30. In this case, the management server 60 acquires the upload file 30 from the file server 50. Specifically, the management server 60 transmits a request indicating the identification information of the upload file 30 to the file server 50. The file server 50 transmits the upload file 30 specified by the identification information indicated in the request to the management server 60.

On the other hand, when no access control template corresponding to the reference location of the upload file 30 is stored in the storage device 62 (S206: No), the management server 60 acquires access right information 12 to be associated with the upload file 30 together with the upload file 30 from the file server 50 (S210). Specifically, the management server 60 transmits a request indicating the identification information of the upload file 30 and the reference location thereof to the file server 50. The file server 50 transmits the upload file specified by the identification information indicated in the request and the access right information 12 for the reference location indicated in the request to the management server 60.

The management server 60 encrypts the upload file 30 and includes the access right information 12 in the metadata of the encrypted upload file 30 (S212). The management server 60 transmits the upload file 30 (i.e., the target file 10), with which the access right information 12 has been associated and which has been encrypted, to the file server 50 (S214). The file server 50 puts the received target file 10 in the storage device 52 (S216). In this process, the original upload file 30 (i.e., the upload file 30 which is not encrypted and not associated with the access right information 12) received from the user apparatus 2000 may be deleted.

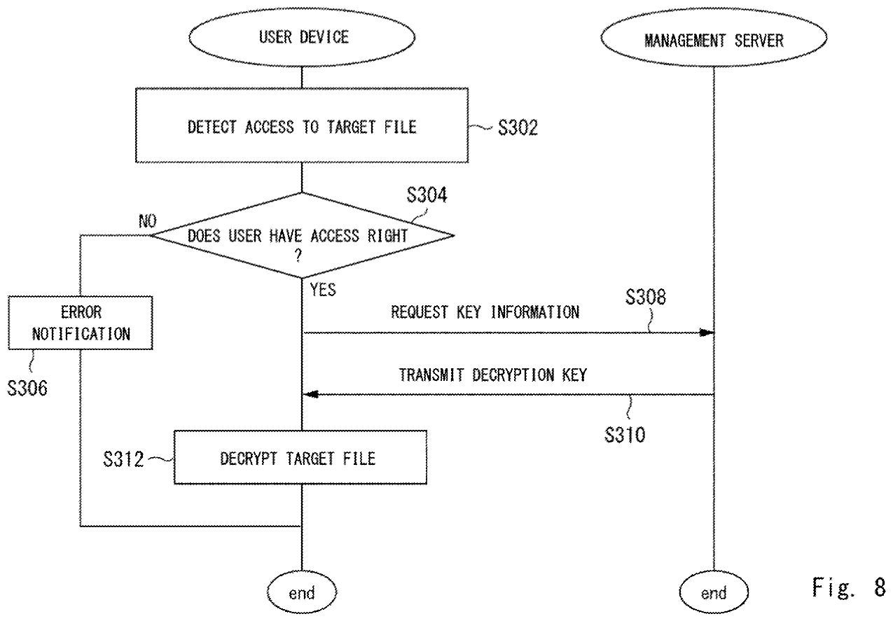

FIG. 8 is a flowchart showing an example of a flow along which the user apparatus 2000 accesses a target file 10. The user apparatus 2000 detects access to the target file 10 (S302). The user apparatus 2000 determines whether or not a user who has accessed (i.e., attempted to access) the target file 10 has an access right for the target file 10 by using the access right information 12 associated with the target file 10 (S304).

When the user does not have the access right for the target file 10 (S304: No), the user apparatus 2000 outputs an error message (S306). On the other hand, when the user has the access right for the target file 10 (S304: Yes), the user apparatus 2000 transmits a request for information necessary for decrypting the target file 10 (hereinafter, called key information) to the management server 60 (S308).

Based on the above-described request, the management server 60 transmits the key information necessary for decrypting the target file 10 to the user apparatus 2000 (S310). The key information contains, for example, a decryption key for decrypting the target file 10.

Note that how the management server 60 acquires the decryption key for the target file 10 is arbitrarily determined. For example, assume that the decryption key for the target file 10 can be generated from an encryption key used to encrypt the target file 10. Further, assume that the encryption key used to encrypt the target file 10 is contained in the metadata of the target file 10. In this case, the user apparatus 2000 acquires the encryption key from the metadata of the target file 10 and includes the acquired encryption key in the request to be transmitted to the management server 60. The management server 60 generates a decryption key by using this encryption key and transmits key information containing the generated decryption key to the user apparatus 2000.

The user apparatus 2000 decrypts the target file 10 by using the acquired key information (S312). As a result, it is possible to access the target file 10. For example, when the access made to the target file 10 is a read, the user can view the contents of the target file 10 through the above-described series of processes. Further, when the access made to the target file 10 is an execution, the user can execute the target file 10 through the above-described series of processes.

Although the present invention is described above with reference to example embodiments, the present invention is not limited to the above-described example embodiments. Various modifications that can be understood by those skilled in the art can be made to the configuration and details of the present invention within the scope of the invention.

Note that, in the above-described examples, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM, CD-R, CD-R/W, and semiconductor memories (such as mask ROM, PROM (Programmable ROM), EPROM (Erasable PROM), flash ROM, RAM, etc.).

Further, the program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The whole or part of the embodiments disclosed above can be described as, but not limited to, the following supplementary notes.

### (Supplementary Note 1)

A management apparatus comprising:
a detection unit configured to detect that a file is uploaded to a file server apparatus;
an acquisition unit configured to acquire the file and access right information indicating an access right for the file from the file server apparatus; and
an output unit configured to encrypt the file, associate the access right information with the encrypted file, and output the file to the file server apparatus.

### (Supplementary Note 2)

The management apparatus according to claim 1, wherein the acquisition unit performs the detection by repeatedly accessing the file server apparatus and determining whether or not there is a newly uploaded file in the file server apparatus.

### (Supplementary Note 3)

The management apparatus according to claim 1, wherein the acquisition unit performs the detection by receiving information about a newly uploaded file from the file server apparatus.

### (Supplementary Note 4)

The management apparatus according to any one of claims 1 to 3,

wherein the acquisition unit performs:
upon the acquisition of the access right information, putting the access right information in a storage device;
when the access right information for the acquired file is not stored in the storage device, acquiring the access right information from the file server apparatus and putting the acquired access right information in the storage device; and
when the access right information for the acquired file is stored in the storage device, acquiring the access right information from the storage device.

### (Supplementary Note 5)

The management apparatus according to any one of claims 1 to 4,

wherein in the access right information, an access right for a file is defined based on a reference location, the reference location being a location where the file was stored at a predetermined time, and

wherein the acquisition unit acquires the access right information corresponding to the reference location of the file.

### (Supplementary Note 6)

The management apparatus according to any one of claims 1 to 5, wherein the management apparatus acquires a request for key information used to decrypt a file from a user apparatus operated by a user, and outputs the key information to the user apparatus.

### (Supplementary Note 7)

The management apparatus according to claim 6,

wherein an encryption key used to encrypt the file is contained in the request, and

wherein the management apparatus generates a decryption key for decrypting the file by using the encryption key contained in the request, and outputs the key information containing the generated decryption key.

(Supplementary note 8)

A control method performed by a management apparatus, comprising:
a detection step of detecting that a file is uploaded to a file server apparatus;
an acquisition step of acquiring the file and access right information indicating an access right for the file from the file server apparatus; and
an output step of encrypting the file, associating the access right information with the encrypted file, and outputting the file to the file server apparatus.

### (Supplementary Note 9)

The control method according to claim 8, wherein, in the acquisition step, the detection is performed by repeatedly accessing the file server apparatus and determining whether or not there is a newly uploaded file in the file server apparatus.

### (Supplementary Note 10)

The control method according to claim 8, wherein, in the acquisition step, the detection is performed by receiving information about a newly uploaded file from the file server apparatus.

### (Supplementary Note 11)

The control method according to any one of claims 8 to 10,

wherein the acquisition step includes:
upon the acquisition of the access right information, putting the access right information in a storage device;
when the access right information for the acquired file is not stored in the storage device, acquiring the access right information from the file server apparatus, and putting the acquired access right information in the storage device; and
when the access right information for the acquired file is stored in the storage device, acquiring the access right information from the storage device.

### (Supplementary Note 12)

The control method according to any one of claims 8 to 11,

wherein in the access right information, an access right for a file is determined based on a reference location, the reference location being a location where the file was stored at a predetermined time, and

wherein in the acquisition step, the access right information corresponding to the reference location of the file is acquired.

### (Supplementary Note 13)

The control method according to any one of claims 8 to 12, wherein a request for key information used to decrypt a file is acquired from a user apparatus operated by a user, and the key information is output to the user apparatus.

### (Supplementary Note 14)

The control method according to claim 13,

wherein an encryption key used to encrypt the file is contained in the request, and

wherein a decryption key for decrypting the file is generated by using the encryption key contained in the request, and the key information containing the generated decryption key is output.

(Supplementary note 15)

A computer readable medium storing a program that causes a management apparatus to perform:
a detection step of detecting that a file is uploaded to a file server apparatus;
an acquisition step of acquiring the file and access right information indicating an access right for the file from the file server apparatus; and
an output step of encrypting the file, associating the access right information with the encrypted file, and outputting the file to the file server apparatus.

### (Supplementary Note 16)

The computer readable medium according to claim 15, wherein, in the acquisition step, the detection is performed by repeatedly accessing the file server apparatus and determining whether or not there is a newly uploaded file in the file server apparatus.

### (Supplementary Note 17)

The computer readable medium according to claim 15, wherein, in the acquisition step, the detection is performed by receiving information about a newly uploaded file from the file server apparatus.

### (Supplementary Note 18)

The computer readable medium according to any one of claims 15 to 17,

wherein the acquisition step includes:
upon the acquisition of the access right information, putting the access right information in a storage device;
when the access right information for the acquired file is not stored in the storage device, acquiring the access right information from the file server apparatus, and putting the acquired access right information in the storage device; and
when the access right information for the acquired file is stored in the storage device, acquiring the access right information from the storage device.

### (Supplementary Note 19)

The computer readable medium according to any one of claims 15 to 18,

wherein in the access right information, an access right for a file is determined based on a reference location, the reference location being a location where the file was stored at a predetermined time, and

wherein in the acquisition step, the access right information corresponding to the reference location of the file is acquired.

### (Supplementary Note 20)

The computer readable medium according to any one of claims 15 to 19, wherein a request for key information used to decrypt a file is acquired from a user apparatus operated by a user, and the key information is output to the user apparatus.

### (Supplementary Note 21)

The computer readable medium according to claim 20,

wherein an encryption key used to encrypt the file is contained in the request, and

wherein a decryption key for decrypting the file is generated by using the encryption key contained in the request, and the key information containing the generated decryption key is output.

### (Supplementary Note 22)

An access control system comprising a file server apparatus and a management apparatus,

wherein the file server apparatus is configured to acquire an uploaded file,

wherein the management apparatus is configured to:
detect that a file is uploaded to the file server apparatus;
acquire the file and access right information indicating an access right for the file from the file server apparatus; and
encrypt the file, associate the access right information with the encrypted file, and output the file to the file server apparatus, and

wherein the file server apparatus is configured to store the file output from the management apparatus in a storage device. An access control system comprising a file server apparatus and a management apparatus,

wherein the file server apparatus is configured to acquire an uploaded file,

wherein the management apparatus is configured to:
detect that a file is uploaded to the file server apparatus;
acquire the file and access right information indicating an access right for the file from the file server apparatus; and
encrypt the file, associate the access right information with the encrypted file, and output the file to the file server apparatus, and

wherein the file server apparatus is configured to store the file output from the management apparatus in a storage device.

### (Supplementary Note 23)

The access control system according to claim 22,

wherein the management apparatus requests, from the file server apparatus, information about a file newly uploaded to the file server apparatus, and

wherein the file server apparatus transmits, in response to the request, information about the newly uploaded file to the management apparatus.

### (Supplementary Note 24)

The access control system according to claim 22, wherein the file server apparatus transmits, upon uploading of a new file, information about the new file to the management apparatus.

### (Supplementary Note 25)

The access control system according to any one of claims 22 to 24,

wherein the management apparatus performs:
upon the acquisition of the access right information, putting the access right information in a storage device;
when the access right information for the acquired file is not stored in the storage device, acquiring the access right information from the file server apparatus and putting the acquired access right information in the storage device; and
when the access right information for the acquired file is stored in the storage device, acquiring the access right information from the storage device.

### (Supplementary Note 26)

The access control system according to any one of claims 22 to 25,

wherein in the access right information, an access right for a file is determined based on a reference location, the reference location being a location where the file was stored at a predetermined time, and

wherein the acquisition unit acquires the access right information corresponding to the reference location of the file.

### (Supplementary Note 27)

The access control system according to any one of claims 22 to 26, further comprising a user apparatus configured to be operated by a user,

wherein the user apparatus transmits, to the management apparatus, a request for key information used to decrypt a file, and

wherein upon receiving the request, the management apparatus outputs the key information to the user apparatus.

### (Supplementary Note 28)

The access control system according to claim 27,

wherein an encryption key used to encrypt the file is contained in the request,

wherein the management apparatus generates a decryption key for decrypting the file by using the encryption key contained in the request, and outputs the key information containing the generated decryption key, and

wherein the user apparatus decrypts the file by using the decryption key contained in the key information.

### REFERENCE SIGNS LIST

10 TARGET FILE
12 ACCESS RIGHT INFORMATION
20 ACCESS RIGHT INFORMATION
30 UPLOAD FILE
50 FILE SERVER
52 STORAGE DEVICE
60 MANAGEMENT SERVER
62 STORAGE DEVICE
70 RIGHT TEMPLATE
80 STORAGE DEVICE
500 COMPUTER
502 BUS
504 PROCESSOR
506 MEMORY
508 STORAGE DEVICE
510 INPUT/OUTPUT INTERFACE
512 NETWORK INTERFACE
2000 USER APPARATUS
3000 FILE SERVER APPARATUS
3100 STORAGE DEVICE
4000 MANAGEMENT APPARATUS
4020 DETECTION UNIT
4040 ACQUISITION UNIT
4060 OUTPUT UNIT
4100 STORAGE DEVICE
5000 ACCESS CONTROL SYSTEM

What is claimed is:

1. A management apparatus comprising:
at least one memory that stores instructions; and
at least one processor that is configured to execute the instructions to:
detect that a file is uploaded to a file server apparatus;
acquire the file and access right information indicating an access right for the file from the file server apparatus; and
encrypt the file, associate the access right information with the encrypted file, and output the file to the file server apparatus.

2. The management apparatus according to claim 1, wherein the detection is performed by repeatedly accessing the file server apparatus and determining whether or not there is a newly uploaded file in the file server apparatus.

3. The management apparatus according to claim 1, wherein the detection is performed by receiving information about a newly uploaded file from the file server apparatus.

4. The management apparatus according to claim 1,
wherein the at least one processor is configured further to:
upon the acquisition of the access right information, put the access right information in a storage device;
when the access right information for the acquired file is not stored in the storage device, acquire the access right information from the file server apparatus and put the acquired access right information in the storage device; and
when the access right information for the acquired file is stored in the storage device, acquire the access right information from the storage device.

5. The management apparatus according to claim 1,
wherein in the access right information, an access right for a file is defined based on a reference location, the reference location being a location where the file was stored at a predetermined time, and
wherein the at least one processor is configured further to acquire the access right information corresponding to the reference location of the file.

6. The management apparatus according to claim 1, wherein the management apparatus acquires a request for key information used to decrypt a file from a user apparatus operated by a user, and outputs the key information to the user apparatus.

7. The management apparatus according to claim 6,
wherein an encryption key used to encrypt the file is contained in the request, and
wherein the management apparatus generates a decryption key for decrypting the file by using the encryption key contained in the request, and outputs the key information containing the generated decryption key.

8. A control method performed by a management apparatus, comprising:
detecting that a file is uploaded to a file server apparatus;
acquiring the file and access right information indicating an access right for the file from the file server apparatus; and
encrypting the file, associating the access right information with the encrypted file, and outputting the file to the file server apparatus.

9. The control method according to claim 8, wherein, the detection is performed by repeatedly accessing the file server apparatus and determining whether or not there is a newly uploaded file in the file server apparatus.

10. The control method according to claim 8, wherein the detection is performed by receiving information about a newly uploaded file from the file server apparatus.

11. The control method according to claim 8,
wherein the control method further comprises:
upon the acquisition of the access right information, putting the access right information in a storage device;
when the access right information for the acquired file is not stored in the storage device, acquiring the access right information from the file server apparatus, and putting the acquired access right information in the storage device; and
when the access right information for the acquired file is stored in the storage device, acquiring the access right information from the storage device.

12. The control method according to claim 8,
wherein in the access right information, an access right for a file is determined based on a reference location, the reference location being a location where the file was stored at a predetermined time, and
wherein the access right information corresponding to the reference location of the file is acquired.

13. The control method according to claim 8, wherein a request for key information used to decrypt a file is acquired from a user apparatus operated by a user, and the key information is output to the user apparatus.

14. The control method according to claim 13,
wherein an encryption key used to encrypt the file is contained in the request, and
wherein a decryption key for decrypting the file is generated by using the encryption key contained in the request, and the key information containing the generated decryption key is output.

15. A non-transitory computer readable medium storing a program that causes a management apparatus to perform:
detecting that a file is uploaded to a file server apparatus;
acquiring the file and access right information indicating an access right for the file from the file server apparatus; and
encrypting the file, associating the access right information with the encrypted file, and outputting the file to the file server apparatus.

16. The computer readable medium according to claim 15, wherein the detection is performed by repeatedly accessing the file server apparatus and determining whether or not there is a newly uploaded file in the file server apparatus.

17. The computer readable medium according to claim 15, wherein the detection is performed by receiving information about a newly uploaded file from the file server apparatus.

18. The computer readable medium according to claim 15,
wherein the program causes the computer to further perform:
upon the acquisition of the access right information, putting the access right information in a storage device;
when the access right information for the acquired file is not stored in the storage device, acquiring the access right information from the file server apparatus, and putting the acquired access right information in the storage device; and
when the access right information for the acquired file is stored in the storage device, acquiring the access right information from the storage device.

19. The computer readable medium according to claim 15,
wherein in the access right information, an access right for a file is determined based on a reference location, the reference location being a location where the file was stored at a predetermined time, and
wherein the access right information corresponding to the reference location of the file is acquired.

20. The computer readable medium according to claim 15, wherein a request for key information used to decrypt a file is acquired from a user apparatus operated by a user, and the key information is output to the user apparatus.

21. The computer readable medium according to claim 20,
wherein an encryption key used to encrypt the file is contained in the request, and
wherein a decryption key for decrypting the file is generated by using the encryption key contained in the request, and the key information containing the generated decryption key is output.

22. An access control system comprising a file server apparatus and a management apparatus,
wherein the file server apparatus comprises at least one memory that stores instructions and at least one processor that is configured to execute the instructions to acquire an uploaded file,
wherein the management apparatus comprises at least one memory that stores instructions and at least one processor that is configured to execute the instructions to:
detect that a file is uploaded to the file server apparatus;
acquire the file and access right information indicating an access right for the file from the file server apparatus; and
encrypt the file, associate the access right information with the encrypted file, and output the file to the file server apparatus, and
wherein the file server apparatus comprises at least one memory that stores instructions and at least one processor that is configured to execute the instructions to store the file output from the management apparatus in a storage device.

23. The access control system according to claim 22,
wherein the at least one processor of the management apparatus is configured further to request, from the file server apparatus, information about a file newly uploaded to the file server apparatus, and
wherein the at least one processor of the file server apparatus is configured to further to transmit, in response to the request, information about the newly uploaded file to the management apparatus.

24. The access control system according to claim 22, wherein the at least one processor of the file server apparatus is configured further to transmit, upon uploading of a new file, information about the new file to the management apparatus.

25. The access control system according to claim 22,
wherein the at least one processor of the management apparatus is configured further to:
upon the acquisition of the access right information, put the access right information in a storage device;
when the access right information for the acquired file is not stored in the storage device, acquire the access right information from the file server apparatus and put the acquired access right information in the storage device; and
when the access right information for the acquired file is stored in the storage device, acquire the access right information from the storage device.

26. The access control system according to claim 22,
wherein in the access right information, an access right for a file is determined based on a reference location, the reference location being a location where the file was stored at a predetermined time, and
wherein the at least one processor of the management apparatus is configured further to acquire the access right information corresponding to the reference location of the file.

27. The access control system according to claim 22, further comprising a user apparatus configured to be operated by a user,
wherein the user apparatus comprises at least one memory that stores instructions and at least one processor that is configured to execute the instructions to transmit, to the management apparatus, a request for key information used to decrypt a file, and
wherein upon receiving the request, the at least one processor of the management apparatus is configured further to output the key information to the user apparatus.

28. The access control system according to claim 27,
wherein an encryption key used to encrypt the file is contained in the request,
wherein the at least one processor of the management apparatus is configured further to generate a decryption key for decrypting the file by using the encryption key contained in the request, and output the key information containing the generated decryption key, and
wherein the at least one processor of the user apparatus is configured further to decrypt the file by using the decryption key contained in the key information.
